(19) United States
(12) Patent Application Publication
(10) Pub. No.: US 2025/0360531 A1
(43) Pub. Date: Nov. 27, 2025

(54) ADHESIVE MATERIAL DISCHARGE DEVICE

(71) Applicant: Si Chan OH, Seoul (KR)

(72) Inventor: Si Chan OH, Seoul (KR)

(21) Appl. No.: 18/290,191

(22) PCT Filed: May 9, 2022
(86) PCT No.: PCT/KR2022/006577

§ 371 Date: Nov. 10, 2023

(30) Foreign Application Priority Data
May 12, 2021 (KR) 10-2021-0061443

(51) Int. Cl. B05C 5/02; B65D 35/02

(52) U.S. Cl. CPC B05C 5/02; B65D 35/02

(57) ABSTRACT

The present invention relates to an adhesive material discharge device and is to provide a device having a pocket containing a liquid adhesive material, wherein when the pocket is pressed by a predetermined force, the liquid adhesive material is discharged and thus filled in a joint, or is applied onto two fixed objects such as a window frame and a glass pane to achieve coupling of the fixed objects. The adhesive material discharge device according to the present invention comprises: a first panel; a second panel disposed above the first panel to be spaced apart therefrom; a plurality of first vibration isolating means which are interposed in an interval space between the first panel and the second panel to be spaced apart from each other and absorb and reduce vibration energy transmitted from the second panel; second vibration isolating means which are interposed in the interval space between the first panel and the second panel to be spaced apart from each other and include curved valley parts and curved ridge parts continuously intersecting each other in a vertical direction to be able to absorb vibration energy while being compressed to a predetermined degree by vibration transmitted from the second panel; a sound absorbing material seated on the upper surface of the second panel; and a fabric member seated on the upper surface of the sound absorbing material.

### TECHNICAL FIELD

The present invention relates to an adhesive material discharge device, and more particularly, to an adhesive material discharge device having a pocket containing a liquid adhesive material, so that, when the pocket is pressed by a predetermined force, the liquid adhesive material is discharged and thus filled in a joint, or is applied onto two fixed objects such as a window frame and a glass pane to achieve coupling of the fixed objects.

### BACKGROUND ART

In general, window frames are installed on balconies of concrete structures such as apartments or buildings, and the window frames are installed with sliding or hinged windows, so as to enable occupants to open and close the windows as needed.

In the above balcony window frame, in order to prevent water from flowing into a room when it rains or snows outside, corners at which the balcony meets the window frame are finished with silicone caulking.

The related art in this regard is disclosed in Utility Model Publication No. 20-2008-0004214 under the title “WATERPROOFING STRUCTURE OF WINDOW FRAME USING RAIN VISOR”.

However, some water upon precipitation may accumulate on the balcony for supporting the window frame as time passes, or expansion and contraction phenomena may occur repeatedly in the balcony as a concrete structure because of temperature changes in the morning and evening due to seasonal changes. These cause the silicone caulking to lift off a surface of the balcony or window frame.

In this case, the water upon precipitation may flow into the room through a gap between the silicone caulking and the surface, thereby causing a water leak. The water leak may also accelerate neutralization of concrete structures in the balcony, thereby reducing durability of the balcony.

Thus, in order to repair the window frame to prevent the water leak, the silicone caulking finished at the corner between the balcony and window frame is removed first, new silicone liquid is injected into the corner between the balcony and the window frame at which the silicone caulking has been removed and then the new silicone liquid is hardened and finished.

However, it is not only very difficult but also time-consuming to completely remove the existing silicone caulking from the corner between the balcony and the window frame, and accordingly, construction costs are increased.

In addition, a window frame and glass for the window frame are coupled through silicone.

Accordingly, it is inconvenient to prepare a silicone gun in order to couple the glass to the window frame.

In addition, in regard to coupling the glass to the window frame, a worker couples the glass to the window frame while applying silicone along an edge of the glass.

However, In the above case, it is difficult to maintain a constant amount of silicone applied along the edge of the glass since the silicone is applied based on the worker's intuition.

Related art documents in the technical field to which the present invention pertain include Korean Patent Publication No. 10-1242622.

### DISCLOSURE

### Technical Problem

In order to solve the above-described problems of the related art, an object of the present invention is to provide an adhesive material discharge device having a pocket containing a liquid adhesive material, so that, when the pocket is pressed by a predetermined force, the liquid adhesive material is discharged and thus filled in a joint, or is applied onto two fixed objects such as a window frame and a glass pane to achieve coupling of the fixed objects.

### Technical Solution

The adhesive material discharge device according to the present invention includes: a liquid adhesive portion; and a pocket portion including an internal space for accommodating the liquid adhesive portion and a discharge port for discharging the liquid adhesive portion, wherein the liquid adhesive portion is discharged through the discharge port when the pocket portion is pressed.

In addition, the pocket portion may include: a first inclined unit coming into contact with the first fixed object; a second inclined unit opposite to the first inclined unit to form the discharge port in the pocket portion, and coming into contact with a second fixed object coming into contact with the first fixed object; and an inclined portion for connecting the first inclined unit and the second inclined unit to each other, wherein, when the inclined portion is pressed, the liquid adhesive portion is discharged by a pressing force and jointly applied to the first inclined unit and the second inclined unit.

In addition, the device further includes at least one shape maintaining portion embedded in the inclined portion to maintain a bent state when the inclined portion is pressed.

In addition, the pocket portion may include: a first inclined unit coming into contact with the first fixed object; a second inclined unit opposite to the first inclined unit to form the discharge port in the pocket portion, and coming into contact with a second fixed object coming into contact with the first fixed object; bend portions extending to be bent from one ends of the first and second inclined units in orthogonal directions and facing each other to form the discharge port; and a curved portion connecting the first inclined unit and the second inclined unit to each other, and formed to have a recessed shape toward a part at which the first fixed object and the second fixed object come into contact with each other.

In addition, the device further includes a cover portion for covering the discharge port while surrounding an outer surface of the pocket portion.

In addition, the pocket portion may have a polyhedral shape, and the pocket portion may be disposed between the first fixed object and the second fixed object disposed to face each other, in which the discharge ports may be formed at regular intervals along corners in the pocket portion that does not face the fixed objects, and when the pocket portion is pressed by the first fixed object or the second fixed object, the liquid adhesive portion may be discharged through each of the discharge ports and jointly applied to the first fixed object and the second fixed object.

In addition, the pocket portion may have a polyhedral shape, and the pocket portion may be disposed between the first fixed object and the second fixed object disposed to face each other, in which at least one discharge port may be formed in the pocket portion on each of surfaces facing the first and second fixed objects, respectively, and when the pocket portion is pressed by the first fixed object or the second fixed object, the liquid adhesive portion may be discharged through the discharge port.

In addition, the device further includes a shape maintaining portion embedded in the pocket portion to traverse the discharge port or traverse the internal space of the pocket portion.

In addition, the pocket portion may have a polyhedral shape, in which a rounded recess portion may be formed in at least one corner of the pocket portion, the discharge ports may be formed in each of the recess portions, and the pocket portion may be disposed between the first fixed object and the second fixed object disposed to face each other, in which, when being pressed by the first fixed object or the second fixed object a piston portion, which presses the liquid adhesive portion while being drawn into the internal space and discharges the liquid adhesive portion through the discharge port, may protrude from the pocket portion.

The adhesive material discharge device according to another embodiment of the present invention includes: a liquid adhesive portion; and a pocket portion including an internal space for accommodating the liquid adhesive portion and formed therein with a tear line having a predetermined pattern, wherein the pocket portion is disposed between the first fixed object and the second fixed object disposed to face each other, and when the pocket portion is pressed by the first fixed object or the second fixed object the tear line is torn and accordingly, the liquid adhesive portion is jointly applied to the first fixed object and the second fixed object.

An adhesive material pressing tool according to another embodiment of the present invention includes: a push rod portion having a circular sectional shape to press the curved portion, and formed on both sides thereof with inclined surfaces, respectively; and a handle coupled to the push rod portion.

### Advantageous Effects

The adhesive material discharge device according to the present invention has a pocket containing a liquid adhesive material, so that, when the pocket is pressed by a predetermined force, the liquid adhesive material can be discharged and thus filled in a joint, or can be applied onto two fixed objects such as a window frame and a glass pane to achieve coupling of the fixed objects.

### DESCRIPTION OF DRAWINGS

FIG. 1 is a view showing an example of an adhesive material discharge device according to the present invention.

FIG. 2 is a view showing a process of filling a joint with the adhesive material discharge device of FIG. 1.

FIG. 3 is a perspective view showing another example of a pocket portion implemented to the adhesive material discharge device according to the present invention.

FIG. 4 is a view showing a process of installing glass onto a window frame by using the adhesive material discharge device of FIG. 3.

FIG. 5 is a perspective view showing another example of the pocket portion and a pressing tool implemented to the adhesive material discharge device according to the present invention.

FIG. 6 is a view showing a process of coupling a first fixed object and a second fixed object by using the adhesive material discharge device of FIG. 5.

FIG. 7 is a perspective view showing another example of the pocket portion implemented to the adhesive material discharge device according to the present invention.

FIG. 8 is a view showing a process of coupling a first fixed object and the second fixed object by using the adhesive material discharge device of FIG. 7.

FIG. 9 is a perspective view showing another example of the pocket portion implemented to the adhesive material discharge device according to the present invention.

FIG. 10 is a view showing a process of coupling a first fixed object and a second fixed object by using the adhesive material discharge device of FIG. 9.

FIGS. 11 and 12 are perspective views showing another example of the pocket portion implemented to the adhesive material discharge device according to the present invention.

FIG. 13 is a view showing a state in which a first fixed object and a second fixed object are coupled using the adhesive material discharge device of FIGS. 11 and 12.

FIG. 14 is a perspective view showing another example of the adhesive material discharge device according to the present invention.

FIG. 15 is a view showing a process of coupling a first fixed object and a second fixed object by using the adhesive material discharge device of FIG. 14.

### BEST MODE

### Mode for Invention

Advantages and features of the present invention, and methods for achieving the advantages and features will be apparent with reference to the embodiments described below in detail with the accompanying drawings.

However, the present invention is not limited to the embodiments described as below and may be implemented in various different forms. The embodiments are provided to complete the disclosure of the present invention and clearly teach the scope of the invention to a person having ordinary skill in the art, and the present invention will be defined only by the scope of claims. The same reference numeral indicates the same element throughout the specification.

Hereinafter, embodiments of the present invention will be described in detail with reference to the attached drawings so that the embodiments may be easily carried out by those having ordinary skill in the art. However, the present invention may be embodied in various different forms and is not limited to the embodiments described herein. Like reference numerals designate like parts throughout the specification.

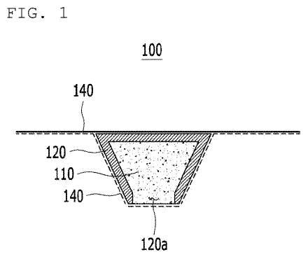

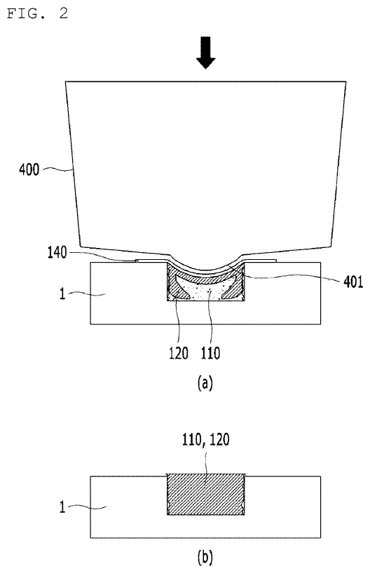

FIG. 1 is a view showing an example of an adhesive material discharge device according to the present invention. FIG. 2 is a view showing a process of filling a joint with the adhesive material discharge device of FIG. 1.

An adhesive material discharge device 100 according to one embodiment of the present invention may include at least one of a liquid adhesive portion 110, a pocket portion 120, and a cover portion 140.

The liquid adhesive portion 110 may be formed of liquid silicone having excellent adhesion.

The liquid adhesive portion 110 is accommodated in the pocket portion 120 without hardening due to exposure to the air.

The pocket portion 120 is formed therein with an internal space for accommodating the liquid adhesive portion 110 as shown in FIG. 1.

The pocket portion 120 may be formed of silicone in a solid form.

For example, the liquid adhesive portion 110 is in a state in which hardening has not occurred because it is not exposed to the air. The pocket portion 120 may be in a state hardening has been completed due to exposure to the air.

The liquid adhesive portion 110 is in a liquid phase and has fluidity compared to the pocket portion 120.

Accordingly, the liquid adhesive portion 110 is subject to the process of hardening after being discharged from the pocket portion 120.

A discharge port 120a is formed in a bottom of the pocket portion 120 to discharge the liquid adhesive portion 110.

When the pocket portion 120 is pressed, the liquid adhesive portion 110 is discharged through the discharge port 120a by a pressing force.

The cover portion 140 is configured to protect the pocket portion 120 and prevent the liquid silicone from being hardened or leaked to the outside.

For example, the cover portion 140 may be implemented in the form of a sticker. The cover portion 140 may be attached to an outer surface of the pocket portion 120 through an adhesive material applied to one surface.

For another example, the cover portion 140 may be implemented as film or vinyl.

In the above case, the cover portion 140 may be attached to the pocket portion 120 through an adhesive.

The cover portion 140 may be provided with two pieces, in which one piece of the cover portion 140 covers a top surface of the pocket portion 120 and the other piece of the cover portion 140 covers the remaining part of the pocket portion 120.

The adhesive material discharge device 100 according to one embodiment of the present invention may fill a groove-shaped joint formed in an object itself through the above configuration.

For example, in the case of a table top plate 1, a joint may be formed thereon with a pattern shape due to design or various other reasons, and the adhesive material discharge device may be used to fill the joint.

In addition, the adhesive material discharge device 100 according to one embodiment of the present invention may also be used to fill a space between tiles.

For example, when a plurality of tiles are installed on a floor or wall, the adhesive material discharge device 100 according to one embodiment of the present invention may also fill joints between the tiles.

FIG. 2 shows an example in which the adhesive material discharge device 100 according to one embodiment of the present invention fills the joint formed on the table top plate 1.

As shown in FIG. 2, when a lower cover portion 140 is peeled off, the pocket portion 120 is inserted into a joint, an upper cover portion is separated, and then an upper surface of the pocket portion 120 is pressed downward using a protruding piece 401 of a pressing tool 400, the liquid adhesive portion 110 is discharged through the discharge port 120a by a pressing force.

The discharged liquid adhesive portion 110 oozes into a gap between the pocket portion 120 and an inner wall of a tile, and hardens over a predetermined period of time, and accordingly, the liquid adhesive portion 110 and the pocket portion 120 fill the joint.

In addition, when the process of discharging the liquid adhesive portion 110 is completed, the cover portion 140 attached to the top surface of the pocket portion 120 may be simply removed.

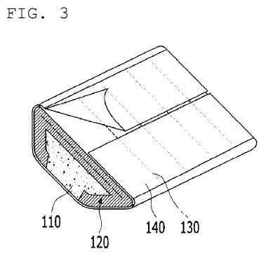

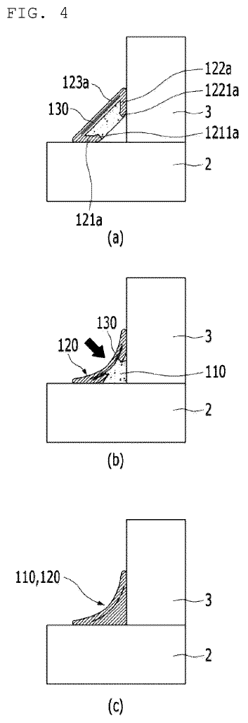

In addition, the adhesive material discharge device 100 according to one embodiment of the present invention may couple a first fixed object 2 to a second fixed object 3 by an attachment scheme as shown FIGS. 3 and 4.

FIG. 3 is a perspective view showing another example of the pocket portion implemented to the adhesive material discharge device according to the present invention. FIG. 4 is a view showing a process of installing a glass pane on a window frame by using the adhesive material discharge device of FIG. 3.

The liquid adhesive portion 110 may be formed of a liquid silicone material as described above, so that various kinds of objects may be fixed to the first fixed object 2 arranged in a horizontal direction and the second fixed object 3 coming into contact with one side of the first fixed object 2.

For example, the adhesive material discharge device 100 according to one embodiment of the present invention may be used to fix glass to a window frame.

The adhesive material discharge device 100 according to one embodiment of the present invention may fix an edge of the glass to the window frame.

Hereinafter, the window frame will be defined as the first fixed object 2 and the glass accommodated inside the window frame will be defined as the second fixed object 3.

The pocket portion 120 may include a first inclined unit 121a coming into contact with the first fixed object 2, a second inclined unit 122a opposite the first inclined unit 121a and coming into contact with the second fixed object 3, and an inclined portion 123a connecting the first inclined unit 121a to the second inclined unit 122a and having a plate shape.

Bent portions 1211a and 1221a extending to be bent in an orthogonal direction and facing each other are formed at ends of the first inclined unit 121a and the second inclined unit 122a, respectively.

The first inclined unit 121a and the second inclined unit 122a have inclination angles gradually closer to each other as extending from one side connected to the inclined portion 123a to the other side, respectively.

In addition, the above-described discharge port 120a is formed between the bent portions 1211a and 1221a.

Due to the inclined portion 123a, the first and second inclined units 121a and 122a, and the bent portions 1211a and 1221a, the internal space is formed inside the pocket portion 120 to accommodate the liquid adhesive portion 110, and the discharge port 120a is formed between the bent portions 1211a and 1221a to discharge the liquid adhesive portion 110. Further, the pocket portion 120 may have a structure in which both sides are open.

Additionally, at least one shape maintaining portion 130 is embedded inside the inclined portion 123a.

The shape maintaining portion 130 may be formed of a metal material to prevent the pocket portion 120 from being restored to its original shape due to its own elastic force when the adhesive material discharge device 100 according to one embodiment of the present invention is implemented to the window frame.

The shape maintaining portion 130 may be implemented to have a simple plate shape or a core shape having a circular section.

When the device according to the present invention is implemented to a window frame to fix glass, the cover portion 140 may be integrally formed with each other.

The cover portion 140 may be formed to be cut in a part positioned at a center of the inclined portion 123a. Accordingly, a user may easily peel off the cover portion 140.

Next, an example in use of the above-described adhesive material discharge device 100 will be described with reference to FIG. 4.

First, the cover portion 140 is peeled from the pocket portion 120.

Thereafter, the first inclined unit 121a comes into contact with the first fixed object 2, and the second inclined unit 122a positioned upward comes into contact with the second fixed object 3.

Thereafter, an approximately central part of the inclined portion 123a is pressed in the directions of the first and second fixed objects.

In the above case, the liquid adhesive portion 110 is discharged through the discharge port 120a by a pressing force, and thus jointly applied to the first fixed object 2 and the second fixed object 3.

Accordingly, an edge of the glass as the second fixed object 3 is adhered and fixed to an inner peripheral surface of the window frame as the first fixed object 2 by the liquid adhesive portion 110.

When the liquid adhesive portion 110 jointly applied to the first fixed object 2 and the second fixed object 3 is hardened, the pocket portion 120 is fixed to connect the first fixed object 2 to the second fixed object 3, so that a bonding force between the first fixed object 2 and the second fixed object 3 is improved.

Edges of the glass may be sequentially coupled to inner surfaces of the window frame in the manner described above.

Further, the pocket portion 120 is configured to have an empty inside. As shown in FIG. 4(c), the inclined portion 123a pressed in the directions of the first and second fixed objects discharges the liquid adhesive portion 110 while being bent in a curved shape.

The pocket portion 120 is formed of a silicone material so that the inclined portion 123a has an elastic force, however, the shape maintaining portion 130 bent together when the inclined portion 123a is bent prevents the inclined portion 123a from being restored to its original shape.

Accordingly, as shown in FIG. 4(C), the inclined portion 123a may consistently maintain the contact state with the first fixed object 2 and the second fixed object 3, and eventually, the first fixed object 2 and the second fixed object 3 are integrally connected to each other via the liquid adhesive portion 110 and the pocket portion 120.

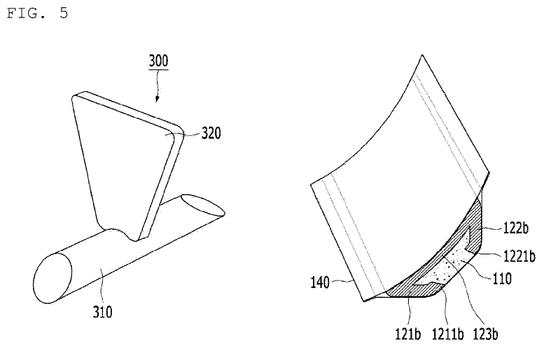

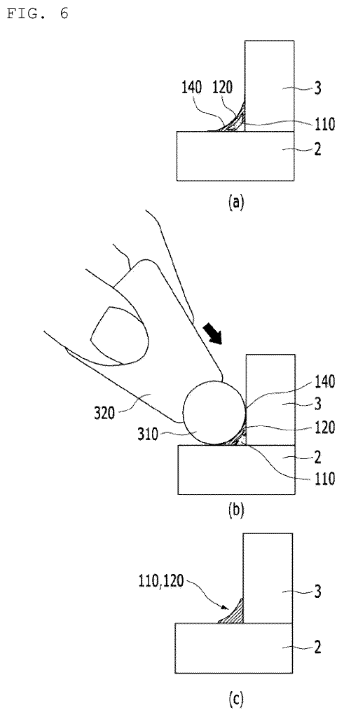

In addition, FIG. 5 is a perspective view showing another example of the pocket portion and a pressing tool implemented to the adhesive material discharge device according to the present invention. FIG. 6 is a view showing a process of coupling the first fixed object and the second fixed object by using the adhesive material discharge device of FIG. 5.

The pocket portion 120 may include a curved portion 123b formed to have a recessed shape toward a part at which the first fixed object 2 and the second fixed object 3 come into contact with each other, a first inclined unit 121b and a second inclined unit 122b formed on one side and the other side of the curved portion 123b, respectively, and having inclination angles gradually closer to each other as extending from one side connected to the curved portion 123b to the other side, respectively, so as to come into contact with the first fixed object 2 and the second fixed object 3, respectively, and bend portions 1211b and 1221b extending to be bent from one ends of the first inclined unit 121b and the second inclined unit 122b in the orthogonal directions and facing each other to form a discharge port 120a.

When the curved portion 123b is formed in the above manner, a restoring force is not large unlike the inclined portion 123a shown in FIG. 4. Thus, the shape maintaining portion 130 may not be required.

Although not shown in the drawings, the shape maintaining portion 130 may be provided to the curved portion 123b.

As shown in FIG. 5, when the pocket portion 120 includes the curved portion 123b, the first inclined unit 121b, the second inclined unit 122b, and the bent portions 1211b and 1221b, a pressing tool 300 according to one embodiment of the present invention may be used.

The pressing tool 300 may include a push rod portion 310 having a circular sectional shape to press the curved portion 123b, and formed on both sides thereof with inclined surfaces, respectively, and a handle 320 coupled to an upper surface of the push rod portion 310.

In other words, as shown in FIG. 6, after the inclined portion 123a comes into contact with the first fixed object 2 and the second fixed object 3, the liquid adhesive portion 110 may be jointly applied to the first fixed object 2 and the second fixed object 3 by pressing the curved portion 123b using the push rod portion 310, so that convenience in use can be improved.

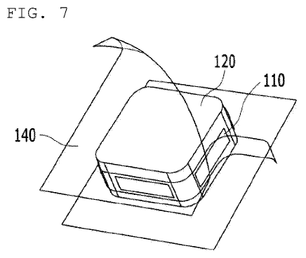

In addition, FIG. 7 is a perspective view showing another example of the pocket portion implemented to the adhesive material discharge device according to the present invention. FIG. 8 is a view showing a process of coupling the first fixed object and the second fixed object by using the adhesive material discharge device of FIG. 7.

The pocket portion 120 may be formed in a polyhedral shape.

The drawing shows an example in which the pocket portion 120 is formed in a hexahedral shape. However, the shape of the pocket portion 120 is not limited to the hexahedral shape.

As in the above, when having the polyhedral shape, the pocket portion 120 is disposed between the first fixed object 2 and the second fixed object 3.

A plurality of discharge ports 120a may be implemented to be formed on upper, lower, left and right surfaces, which are surfaces that do not face the first and second fixed objects 2 and 3, in the pocket portion 120, respectively, based on FIG. 8.

In addition, three cover portions 140 may be provided. The two cover portions 140 are formed in a square plate shape and attached to front and rear surfaces of the pocket portion 120, respectively, and the one cover portion 140 is formed in a strip shape and attached along corners of the pocket portion 120.

The strip-shaped cover portion 140 prevents the liquid adhesive portion from being hardened due to exposure to the air.

The liquid adhesive portion 110 and the pocket portion 120 of the present embodiment may be used to couple other first and second fixed objects 2 and 3 other than the window frame and glass.

The first fixed object 2 and the second fixed object 3 may be formed of a wood or metal material.

In this embodiment, types of the first fixed object 2 and the second fixed object 3 are not limited.

Next, an example in use of the adhesive material discharge device 100 according to an embodiment of the present invention will be described with reference to FIG. 8.

First, the cover portions 140 attached to the upper and lower surfaces of the pocket portion 120 and the strip-shaped cover portion 140 attached along the corners of the pocket portion 120 are peeled off.

Thereafter, the pocket portion 120 is positioned between the first fixed object 2 and the second fixed object 3.

Thereafter, the pocket portion 120 is pressed using the first fixed object or the second fixed object 3.

The pocket portion 120 is compressed by the pressing force of the first fixed object 2 or the second fixed object 3, and the liquid adhesive portion 110 accommodated in the internal space of the pocket portion 120 is discharged through each of the discharge ports 120a, and accordingly, jointly applied to the first fixed object 2 and the second fixed object 3.

In addition, when a predetermined period of time passes, the liquid adhesive portion 110 hardens and becomes in the same state as the pocket portion 120, so that the first fixed object 2 and the second fixed object 3 are coupled to each other via the liquid adhesive portion 110 and the pocket portion 120.

The shape maintaining portion 130 may also be provided in this embodiment.

The shape maintaining portion 130 may be embedded in the pocket portion 120 to traverse a predetermined two discharge ports 120a.

The shape maintaining portion 130 may maintain a straight line-shape before the pocket portion 120 is pressed by the first fixed object 2 or the second fixed object 3. However, when the pocket portion 120 is pressed by the first fixed object 2 or the second fixed object 3, the shape maintaining portion is bent into an irregular shape, so that the pocket portion 120 may be prevented from being restored to its original shape by its own elastic force.

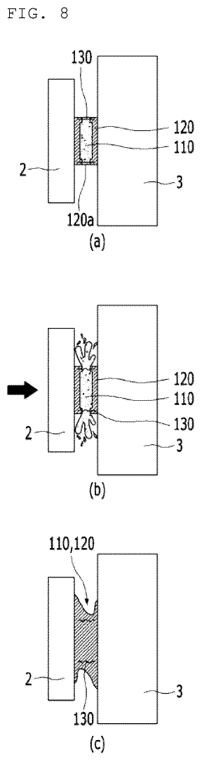

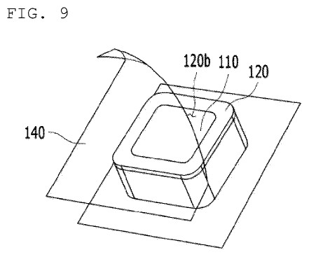

In addition, FIG. 9 is a perspective view showing another example of the pocket portion implemented to the adhesive material discharge device according to the present invention. FIG. 10 is a view showing a process of coupling the first fixed object and the second fixed object by using the adhesive material discharge device of FIG. 9.

The pocket portion 120 may be formed in a polyhedral shape.

The drawing shows an example in which the pocket portion 120 is formed in a hexahedral shape. However, the shape of the pocket portion 120 is not limited to the hexahedral shape.

In this embodiment, each corner part of the pocket portion 120 may be formed in a curved shape.

As in the above, when being formed in a polyhedral shape, the pocket portion 120 is disposed between the first fixed object 2 and the second fixed object 3.

A plurality of discharge ports 120a may be implemented in which at least one discharge port may be formed in the pocket portion 120 on each of front and rear surfaces facing the first and second fixed objects 2 and 3.

In addition, two cover portions 140 may be provided. The cover portion 140 are formed in a square plate shape and attached to front and rear surfaces of the pocket portion 120, respectively.

The liquid adhesive portion 110 and the pocket portion 120 of the present embodiment may be used to couple other first and second fixed objects 2 and 3 other than the window frame and glass.

The first fixed object 2 and the second fixed object 3 may be formed of a wood or metal material.

In this embodiment, types of the first fixed object 2 and the second fixed object 3 are not limited.

Next, an example in use of the adhesive material discharge device 100 according to an embodiment of the present invention will be described with reference to FIG. 10.

First, the cover portions 140 attached to the upper and lower surfaces of the pocket portion 120 and the strip-shaped cover portion 140 attached along the corners of the pocket portion 120 are peeled off.

Thereafter, the pocket portion 120 is positioned between the first fixed object 2 and the second fixed object 3.

Thereafter, the pocket portion 120 is pressed using the first fixed object or the second fixed object 3.

The pocket portion 120 is compressed by the pressing force of the first fixed object 2 or the second fixed object 3, and the liquid adhesive portion 110 accommodated in the internal space of the pocket portion 120 is discharged through each of the discharge ports 120a, and accordingly, jointly applied to the first fixed object 2 and the second fixed object 3.

In addition, when a predetermined period of time passes, the liquid adhesive portion 110 hardens and becomes in the same state as the pocket portion 120, so that the first fixed object 2 and the second fixed object 3 are coupled to each other via the liquid adhesive portion 110 and the pocket portion 120.

The shape maintaining portion 130 may also be provided in this embodiment.

The shape maintaining portion 130 may be embedded in the pocket portion 120 to traverse the internal space of the pocket portion 120.

The shape maintaining portion 130 may maintain a straight line-shape before the pocket portion 120 is pressed by the first fixed object 2 or the second fixed object 3. However, when the pocket portion 120 is pressed by the first fixed object 2 or the second fixed object 3, the shape maintaining portion is bent into an irregular shape, so that the pocket portion 120 may be prevented from being restored to its original shape by its own elastic force.

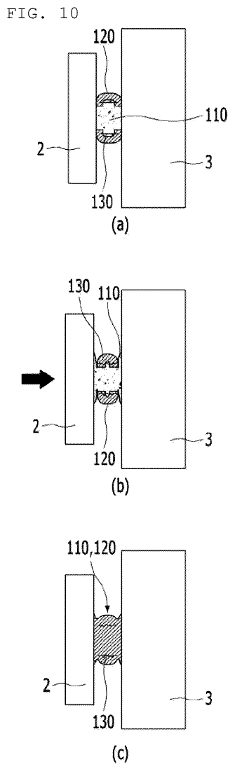

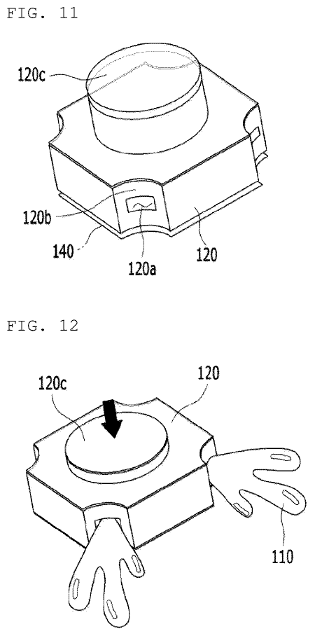

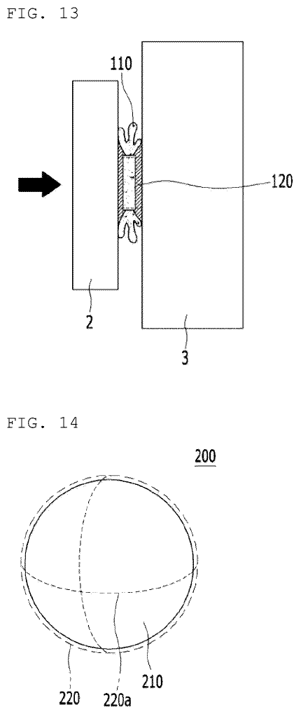

In addition, FIGS. 11 and 12 are perspective views showing another example of the pocket portion implemented to the adhesive material discharge device according to the present invention. FIG. 13 is a view showing a state in which a first fixed object and a second fixed object are coupled using the adhesive material discharge device of FIGS. 11 and 12.

The pocket portion 120 may be formed in a polyhedral shape.

The drawing shows an example in which the pocket portion 120 is formed in a hexahedral shape. However, the shape of the pocket portion 120 is not limited to the hexahedral shape.

In this embodiment, a rounded recess portion 120b is formed in at least one corner of the pocket portion 120.

The drawing shows an example in which the recess portions 120b are formed at the corners of the pocket portion 120, respectively.

Discharge ports 120a may be formed in the recess portions 120b, respectively.

As in the above, when being formed in a polyhedral shape, the pocket portion 120 is disposed between the first fixed object 2 and the second fixed object 3.

In addition, a hollow is formed in the pocket portion 120, and a piston portion 120c is inserted into the hollow.

The piston portion 120c may be drawn into the internal space of the pocket portion 120 through the hollow.

In other words, when the piston 120c is pressed by using the first fixed object 2 or the second fixed object 3, the piston 120c is drawn into the internal space of the pocket portion 120, so that the liquid adhesive portion 110 is pressed and discharged through the discharge ports 120a.

In addition, one cover portion 140 may be provided. The cover portion 140 is attached to jointly surround the pocket portion 120 and the piston portion 120c.

The liquid adhesive portion 110 and the pocket portion 120 of the present embodiment may be used to couple other first and second fixed objects 2 and 3 other than the window frame and glass.

The first fixed object 2 and the second fixed object 3 may be formed of a wood or metal material.

In this embodiment, types of the first fixed object 2 and the second fixed object 3 are not limited.

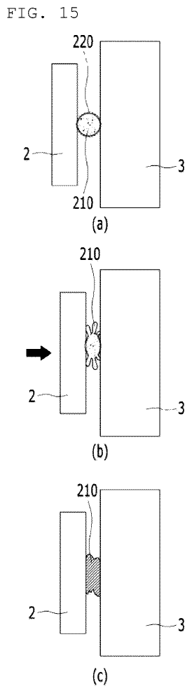

In addition, FIG. 14 is a perspective view showing another example of the adhesive material discharge device according to the present invention. FIG. 15 is a view showing a process of coupling the first fixed object and the second fixed object by using the adhesive material discharge device of FIG. 14.

An adhesive material discharge device 200 according to an embodiment of the present invention may include a liquid adhesive portion 210 and a pocket portion 220.

The liquid adhesive portion 210 may be formed of liquid silicone.

The pocket portion 220 may be formed in a spherical shape, and may accommodate the liquid adhesive portion 210 in an internal space.

The pocket portion 220 may be formed of vinyl or film.

A tear line 220a having a predetermined pattern may be formed in the pocket portion 220.

The tear line 220a may be formed in the same shape as a known tear line.

In addition, the drawing shows an example in which tear lines 220a are formed in a criss-cross shape when the pocket portion 220 is viewed from the front.

The liquid adhesive portion 210 and the pocket portion 220 of the present embodiment may be used to couple other first and second fixed objects 2 and 3 other than the window frame and glass.

The first fixed object 2 and the second fixed object 3 may be formed of a wood or metal material.

In this embodiment, types of the first fixed object 2 and the second fixed object 3 are not limited.

Next, an example in use of the adhesive material discharge device 200 according to an embodiment of the present invention will be described with reference to FIG. 15.

First, the pocket portion 220 is positioned between the first fixed object 2 and the second fixed object 3.

Thereafter, the pocket portion 220 is pressed using the first fixed object or the second fixed object 3.

The pocket portion 220 is compressed by the pressing force of the first fixed object 2 or the second fixed object 3, and the liquid adhesive portion 210 accommodated in the internal space of the pocket portion 220 is discharged through each of the discharge ports 120a, and accordingly, jointly applied to the first fixed object 2 and the second fixed object 3.

In addition, when a predetermined period of time passes, the liquid adhesive portion 210 hardens and becomes in the same state as the pocket portion 220, so that the first fixed object 2 and the second fixed object 3 are coupled to each other via the liquid adhesive portion 210 and the pocket portion 220.

It will be apparent that a person having ordinary skill in the art may carry out various deformations and modifications within the scope without departing from the idea of the present invention, the following claims and equivalents thereof. Therefore, the above described embodiments will be understood in all respects as illustrative and not restrictive. The scope of the present invention is defined by the following claims rather than the above detailed description, and all deformations or modifications derived from the idea and scope of the claims and their equivalents will be construed as being included in the scope of the present invention.

### DESCRIPTION OF REFERENCE NUMERALS

100,200: Adhesive material discharge device
110,210: Liquid adhesive portion
120,220: Pocket portion 120a: Discharge port
120b: Recess portion 120c: Piston
121a,121b: First inclined unit
1211a,1221a,1211b,1221b: Bent portion
122a,122b: Second inclined unit
123a: Inclined portion 123b: Curved portion
130: Shape maintaining portion
140: Cover portion 220a: Tear line
300,400: Pressing tool 310: Push rod portion
320: Handle 401: Protrusion piece

1. An adhesive material discharge device comprising:
a liquid adhesive portion; and
a pocket portion including an internal space for accommodating the liquid adhesive portion and a discharge port for discharging the liquid adhesive portion, wherein
the liquid adhesive portion is discharged through the discharge port when the pocket portion is pressed.

2. The adhesive material discharge device of claim 2, wherein
the pocket portion includes:
a first inclined unit coming into contact with the first fixed object;
a second inclined unit opposite to the first inclined unit to form the discharge port in the pocket portion, and coming into contact with a second fixed object coming into contact with the first fixed object; and
an inclined portion for connecting the first inclined unit and the second inclined unit to each other, and wherein
the liquid adhesive portion is discharged by a pressing force and jointly applied to the first inclined unit and the second inclined unit when the inclined portion is pressed.

3. The adhesive material discharge device of claim 2, further comprising:
at least one shape maintaining portion embedded in the inclined portion to maintain a bent state when the inclined portion is pressed.

4. The adhesive material discharge device of claim 1, wherein
the pocket portion includes:
a first inclined unit coming into contact with the first fixed object;
a second inclined unit opposite to the first inclined unit to form the discharge port in the pocket portion, and coming into contact with a second fixed object coming into contact with the first fixed object;
bend portions extending to be bent from one ends of the first and second inclined units in orthogonal directions and facing each other to form the discharge port; and
a curved portion connecting the first inclined unit and the second inclined unit to each other and formed to have a recessed shape toward a part at which the first fixed object and the second fixed object come into contact with each other.

5. The adhesive material discharge device of claim 1, further comprising:
a cover portion for covering the discharge port while surrounding an outer surface of the pocket portion.

6. The adhesive material discharge device of claim 1, wherein
the pocket portion has a polyhedral shape,
the pocket portion is disposed between the first fixed object and the second fixed object disposed to face each other,
the discharge port is formed at regular intervals along corners of the pocket portion that does not face the fixed objects, and
the liquid adhesive portion is discharged through each of the discharge ports and jointly applied to the first fixed object and the second fixed object when the pocket portion is pressed by the first fixed object or the second fixed object.

7. The adhesive material discharge device of claim 1, wherein
the pocket portion has a polyhedral shape,
the pocket portion is disposed between the first fixed object and the second fixed object disposed to face each other,
at least one discharge port is formed in the pocket portion on each of surfaces facing the first and second fixed objects, respectively, and
the liquid adhesive portion is discharged through the discharge port when the pocket portion is pressed by the first fixed object or the second fixed object.

8. The adhesive material discharge device of claim 6 or 7, further comprising:
a shape maintaining portion embedded in the pocket portion to traverse the discharge port or traverse the internal space of the pocket portion.

9. The adhesive material discharge device of claim 1, wherein
the pocket portion has a polyhedral shape, in which a rounded recess portion is formed in at least one corner of the pocket portion and the discharge port is formed in the recess portion,
the pocket portion is disposed between the first fixed object and the second fixed object disposed to face each other, and
the pocket portion has a piston portion protruding to press the liquid adhesive portion while being drawn into the internal space and discharge the liquid adhesive portion through the discharge port when the pocket portion is pressed by the first fixed object or the second fixed object.

10. An adhesive material discharge device comprising:
a liquid adhesive portion; and
a pocket portion including an internal space for accommodating the liquid adhesive portion and formed therein with a tear line having a predetermined pattern, wherein
the pocket portion is disposed between the first fixed object and the second fixed object disposed to face each other, and
the tear line is torn when the pocket portion is pressed by the first fixed object or the second fixed object and accordingly, the liquid adhesive portion is jointly applied to the first fixed object and the second fixed object.

11. A pressing tool comprising:
a push rod portion having a circular sectional shape to press a curved portion of claim 4, and formed on both sides thereof with inclined surfaces, respectively; and
a handle coupled to the push rod portion.
